(19) United States
(12) Patent Application Publication
(10) Pub. No.: US 2013/0262238 A1
(43) Pub. Date: Oct. 3, 2013

(54) System and method for customer involvement

(71) Applicant: Mikhail Leonidovich Liubachev, Saint-Petersburg (RU)

(72) Inventor: Mikhail Leonidovich Liubachev, Saint-Petersburg (RU)

(21) Appl. No.: 13/855,722

(22) Filed: Apr. 3, 2013

Related U.S. Application Data
(60) Provisional application No. 61/697,311, filed on Sep. 6, 2012.

(51) Int. Cl. G06Q 30/02

(52) U.S. Cl. CPC G06Q 30/0269
USPC 705/14.66

(57) ABSTRACT

A computer-implemented method for a customer involvement, comprising: creating or obtaining from one or more external sources, on a first computer system, a one or more parameters dependent filter for further promo-campaign distribution, wherein the one or more parameters dependent filter comprises one or more parameters; linkage, on the first computer system, of the created one or more parameters dependent filter with one or more preliminary created promo-campaigns; wherein the promo-campaign comprising an advertising and/or promotion information about one or more goods and/or services; distributing the one or more promo-campaigns associated with linked set of parameters from the one or more parameters dependent filter to the one or more computer systems, which correspond with set of the parameters listed in the one or more parameters dependent filter.

### FIELD OF INVENTION

This invention relates to the information technology field. More particularly, the present invention relates to the systems and methods for potential customer detection as well as goods and/or services promotion.

### RELATED ART

The advertising market is growing very rapidly. In the period between 2000 and 2012, electronic and online advertisement methods have evolved from simple banners to advertisements on mobile devices using geographical location.

When computers and portable devices were not popular, companies promoted their goods and/or services by publishing their offers, typically with discounts, in newspapers or specialized classified boards. To buy an item or redeem a coupon, the potential customer needed to cut the coupon from the newspaper, find the geographical location of the company's point of sale, come to this point of sale during the period of the promo-campaign, show the coupon to the company's employee and purchase goods and/or services with the discount. This was a very long and complicated process. The potential customer needed to plan the shopping activities beforehand, he/she could lose the coupon, could forget to redeem the coupon, could come to the point of sale after the period of the promo-campaign availability, etc.

With the growing popularity of computers came the Groupon® website, which offered daily deals within one or more cities. At that time, users could explore the daily deals created in their city and participate in them by purchasing a coupon with, typically, a unique code generated by Groupon®, a map of the geographical location where potential customers could redeem the coupon and the period of the promo-campaign. The method of promotion was as follows: First, the potential customer needed to review a large number of offers. Second, the potential customer needed to identify whether the geographical location of the point of sale was located near places that he/she usually visited. Then, the potential customer needed to plan his/her purchasing activities beforehand because of the limited duration of the offer from the promo-campaign. After purchasing and before redeeming, the potential customer had to print the coupon and then come to the point of sale to redeem it. The disadvantages of this approach are as follows:
1 the potential customer had to change the typical route to home or work only for the purpose of redeeming the coupon and purchasing necessary goods and/or services;
2 the potential customer had to plan his/her visit to the point of sale beforehand. In some cases, the potential customer may have forgotten about the duration of the offer and, therefore, did not participate in the promo-campaign;
3 if the potential customer did not participate in the promo-campaign, he/she will have lost the money that he/she paid for the coupon.

With the advent of mobile portable devices, such as Apple® iPhone®, iPod Touch®, Samsung® Galaxy®, Microsoft® Surface®, Apple® iPad®, Android® smartphones, etc., the methods of promotion further improved. For example, Pirq® software application for portable devices (at the moment of filing this patent application, the services released only iOS® and Android® versions of the software application) filters the promo-campaigns that are located near the current location of the potential customer. The application works as follows. First, the software application identifies the geographical location of the potential customer. Second, the software calculates the distance to the point of sale. And third, the software displays the list of the promo-campaigns with the offerings sorted by the distance from the current geographical location of the potential customer. If the potential customer wants to purchase one or more goods and/or services, he clicks on the participation button. To redeem the offer, the potential customer needs to come to the point of sale and make a photo of the unique picture or code. This approach still has some big disadvantages:
the nearest point of sale can be very far away from the current geographical location of the potential customer.
if this is the case, the first and second disadvantages of the previous approach are applicable as well.

Accordingly, the present invention solves the above-mentioned problems and offers a brand new way for goods and/or services promotion and customer detection.

### SUMMARY OF THE INVENTION

In accordance with some embodiments of the present invention, a computer-implemented method for a customer involvement, comprising: creating or obtaining from one or more external sources, on a first computer system, a one or more parameters dependent filter for further promo-campaign distribution, wherein the one or more parameters dependent filter comprises one or more parameters; linkage, on the first computer system, of the created one or more parameters dependent filter with one or more preliminary created promo-campaigns; wherein the promo-campaign comprising an advertising and/or promotion information about one or more goods and/or services; distributing the one or more promo-campaigns associated with linked set of parameters from the one or more parameters dependent filter to the one or more computer systems, which correspond with set of the parameters listed in the one or more parameters dependent filter.

In some embodiments of the present invention, a computer-implemented method for a customer involvement, comprising: creating or obtaining, on a first computer system, one or more promo-campaigns; wherein the promo-campaign comprises an advertising and/or promotion information about one or more goods and/or services and one or more parameters, corresponding to the one or more promo-campaigns distribution; receiving, on the first computer system, one or more parameters from one or more computer systems; distributing the one or more promo-campaigns to the one or more computer systems, If one or more received parameters correspond to one or more parameters of the one or more promo-campaigns.

In some embodiments of the present invention, a computer-implemented method for a customer involvement, comprising: creating, on a first computer system, a one or more parameters dependent filter for further promo-campaign distribution, wherein the one or more parameters dependent filter comprises a list of parameters; linkage, on the first computer system, of the created one or more parameters dependent filter with one or more preliminary created promo-campaigns; wherein the promo-campaign comprising an advertising and/or promotion information about one or more goods and/or services; receiving, on the first computer system, the one or more parameters from the one or more computer systems; identifying if one or more received parameters correspond with set of the selected parameters listed in the one or more parameters dependent filter; distributing the one or more promo-campaigns with linked one or more necessary parameters dependent filter to the one or more computer systems, which previously sent the one or more parameters to the first computer system, if one or more received parameters correspond with set of parameters listed in the one or more parameters dependent filter.

In some embodiments of the present invention, a computer-implemented method for a customer involvement, comprising: creating or obtaining from one or more external sources, on a first computer system, a one or more parameters dependent filter for further promo-campaign distribution, wherein the one or more parameters dependent filter comprises a list of parameters; linkage, on the first computer system, of the created one or more parameters dependent filter with one or more preliminary created promo-campaigns; wherein the promo-campaign comprising an advertising and/or promotion information about one or more goods and/or services; wherein the one or more promo-campaigns are unavailable for all computer systems, except one or more computer systems, that have means for one or more promo-campaigns management and/or usage, and/or involved one or more computer systems; receiving, on the first computer system, the one or more parameters from the one or more computer systems; identifying if one or more received parameters correspond with set of the parameters listed in the one or more parameters dependent filter; making available one or more promo-campaigns with linked one or more necessary parameters dependent filter to the one or more computer systems, which sent the one or more parameters to the first computer system, if one or more received parameters correspond with set of the parameters listed in the one or more parameters dependent filter.

In some embodiments of the present invention, a computer-implemented method for a customer involvement, comprising: creating or obtaining from one or more external sources, on a first computer system, a one or more parameters dependent filter for further promo-campaign distribution, wherein the one or more parameters dependent filter comprises a list of parameters; linkage, on the first computer system, of the created one or more parameters dependent filter with one or more preliminary created promo-campaigns; wherein the promo-campaign comprising an advertising and/or promotion information about one or more goods and/or services; receiving, on the first computer system, the one or more parameters from the one or more computer systems; identifying if one or more received parameters correspond with set of the parameters listed in the one or more parameters dependent filter; distributing the one or more promo-campaigns with linked one or more necessary parameters dependent filter to the one or more computer systems, which previously sent the one or more parameters to the first computer system, if one or more received parameters correspond with set of parameters listed in the one or more parameters dependent filter.

In some embodiments of the present invention, a computer-implemented method for a customer involvement, comprising: creating or obtaining from one or more external sources, on a first computer system, a one or more parameters dependent filter for further promo-campaign distribution, wherein the one or more parameters dependent filter comprises a list of parameters for selection; linkage, on the first computer system, of the created one or more parameters dependent filter with one or more preliminary created promo-campaigns; wherein the promo-campaign comprising an advertising and/or promotion information about one or more goods and/or services, which can be purchased in one or more point of sales and/or electronically; sending one or more requests, from one or more computer systems to the first computer system, for a list of one or more promo-campaigns, which correspond with set of parameters listed in the one or more parameters dependent filter, wherein the one or more requests comprises one or more parameters, corresponding to the one or more parameters dependent filter, of the one or more computer systems; identifying if one or more received parameters correspond with one or more parameters listed in the one or more parameters dependent filter; distributing a list of the one or more promo-campaigns with linked one or more necessary parameters dependent filter to the one or more computer systems, if one or more received parameters correspond with one or more parameters listed in the one or more parameters dependent filter, wherein the list of the one or more promo-campaigns comprises part of the advertising and/or promotion information about one or more goods and/or services.

In some embodiments of the present invention, a system for a customer involvement, comprising: one or more processors; one or more devices for storing data; one or more devices for establishing a network connection with one or more computer systems; one or more programs, stored in the one or more devices for storing data and configured to be executed by the one or more processors, the one or more programs containing instructions for: creating or obtaining from one or more external sources a one or more parameters dependent filter for further promo-campaign distribution, wherein the one or more parameters dependent filter comprises one or more parameters; linkage of the created one or more parameters dependent filter with one or more preliminary created promo-campaigns; wherein the promo-campaign comprising an advertising and/or promotion information about one or more goods and/or services; distributing the one or more promo-campaigns associated with linked set of parameters from the one or more parameters dependent filter to the one or more computer systems, which correspond with set of the parameters listed in the one or more parameters dependent filter.

In some embodiments of the present invention, a system for a customer involvement, comprising: one or more processors; one or more devices for storing data; one or more devices for establishing a network connection with one or more computer systems; one or more programs, stored in the one or more devices for storing data and configured to be executed by the one or more processors, the one or more programs containing instructions for: creating one or more promo-campaigns; wherein the promo-campaign comprises an advertising and/or promotion information about one or more goods and/or services and one or more parameters, corresponding to the one or more promo-campaigns distribution; receiving one or more parameters from one or more computer systems; distributing the one or more promo-campaigns to the one or more computer systems, If one or more received parameters correspond to one or more parameters of the one or more promo-campaigns.

In some embodiments of the present invention, a system for a customer involvement, comprising: one or more processors; one or more devices for storing data; one or more devices for establishing a network connection with one or more computer systems; one or more programs, stored in the one or more devices for storing data and configured to be executed by the one or more processors, the one or more programs containing instructions for: creating or obtaining from one or more external sources a one or more parameters dependent filter for further promo-campaign distribution, wherein the one or more parameters dependent filter comprises a list of parameters; linkage of the created one or more parameters dependent filter with one or more preliminary created promo-campaigns; wherein the promo-campaign comprising an advertising and/or promotion information about one or more goods and/or services; receiving the one or more parameters from the one or more computer systems; identifying if one or more received parameters correspond with parameters listed in the one or more parameters dependent filter; distributing the one or more promo-campaigns with linked one or more parameters dependent filter to the one or more computer systems, which previously sent the one or more parameters to the first computer system, if one or more received parameters correspond with set of parameters listed in the one or more parameters dependent filter.

In some embodiments of the present invention, a system for a customer involvement, comprising: one or more processors; one or more devices for storing data; one or more devices for establishing a network connection with one or more computer systems; one or more programs, stored in the one or more devices for storing data and configured to be executed by the one or more processors, the one or more programs containing instructions for: creating or obtaining from one or more external sources a one or more parameters dependent filter for further promo-campaign distribution, wherein the one or more parameters dependent filter comprises a list of parameters; linkage of the created one or more parameters dependent filter with one or more preliminary created promo-campaigns; wherein the promo-campaign comprising an advertising and/or promotion information about one or more goods and/or services; wherein the one or more promo-campaigns are unavailable for all computer systems, except the system for a customer involvement; receiving the one or more parameters from the one or more computer systems; identifying if one or more received parameters correspond with set of the parameters listed in the one or more parameters dependent filter; making available one or more promo-campaigns with linked one or more necessary parameters dependent filter to the one or more computer systems, which sent the one or more parameters to the first computer system, if one or more received parameters correspond with set of the parameters listed in the one or more parameters dependent filter.

In some embodiments of the present invention, a system for a customer involvement, comprising: one or more processors; one or more devices for storing data; one or more devices for establishing a network connection with one or more computer systems; one or more programs, stored in the one or more devices for storing data and configured to be executed by the one or more processors, the one or more programs containing instructions for: creating or obtaining from one or more external sources a one or more parameters dependent filter for further promo-campaign distribution, wherein the one or more parameters dependent filter comprises a list of parameters; linkage of the created one or more parameters dependent filter with one or more preliminary created promo-campaigns; wherein the promo-campaign comprising an advertising and/or promotion information about one or more goods and/or services; receiving the one or more parameters from the one or more computer systems; identifying if one or more received parameters correspond with set of the parameters listed in the one or more parameters dependent filter; distributing the one or more promo-campaigns with linked one or more necessary parameters dependent filter to the one or more computer systems, which previously sent the one or more parameters to the first computer system, if one or more received parameters correspond with set of parameters listed in the one or more parameters dependent filter.

In some embodiments of the present invention, a system for a customer involvement, comprising: one or more processors; one or more devices for storing data; one or more devices for establishing a network connection with one or more computer systems; one or more programs, stored in the one or more devices for storing data and configured to be executed by the one or more processors, the one or more programs containing instructions for: creating or obtaining from one or more external sources, on a first computer system, a one or more parameters dependent filter for further promo-campaign distribution, wherein the one or more parameters dependent filter comprises a list of parameters for selection; linkage, on the first computer system, of the created one or more parameters dependent filter with one or more preliminary created promo-campaigns; wherein the promo-campaign comprising an advertising and/or promotion information about one or more goods and/or services, which can be purchased in one or more point of sales and/or electronically; sending one or more requests, from one or more computer systems to the first computer system, for a list of one or more promo-campaigns, which correspond with set of parameters listed in the one or more parameters dependent filter, wherein the one or more requests comprises one or more parameters, corresponding to the one or more parameters dependent filter, of the one or more computer systems; identifying if one or more received parameters correspond with one or more parameters listed in the one or more parameters dependent filter; distributing a list of the one or more promo-campaigns with linked one or more necessary parameters dependent filter to the one or more computer systems, if one or more received parameters correspond with one or more parameters listed in the one or more parameters dependent filter, wherein the list of the one or more promo-campaigns comprises part of the advertising and/or promotion information about one or more goods and/or services.

### BRIEF DESCRIPTION OF THE DRAWINGS

For a better understanding of the aforementioned embodiments of the invention as well as additional embodiments thereof, reference should be made to the detailed description below, in conjunction with the following drawings in which like reference numerals refer to corresponding parts throughout the figures.

FIG. 1 illustrates the method for customer detection according to some embodiments of the present invention.

FIG. 2 illustrates the system that implements the method shown in FIG. 1, according to some embodiments of the present invention.

FIG. 3 illustrates the graphical user interface of promo-campaign creation according to some embodiments of the present invention.

FIG. 4 illustrates one of the embodiments of the present invention.

FIG. 5 illustrates the description of the promo-campaign according to some embodiments of the present invention.

FIG. 6 shows the graphical user interface according to some embodiments of the present invention.

FIG. 7 shows the method of changing the state of the user according to some embodiments of the present invention.

FIG. 8 illustrates one of the embodiments of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the system and method of customer detection are described. For purposes of explanation, the “computer system” means a computer system that has the means to utilize some embodiments of the present invention, for example, personal computer with Windows, Mac or Linux; portable multifunction device, such as cellphone, smartphone, PDA, tablet PC; laptop.

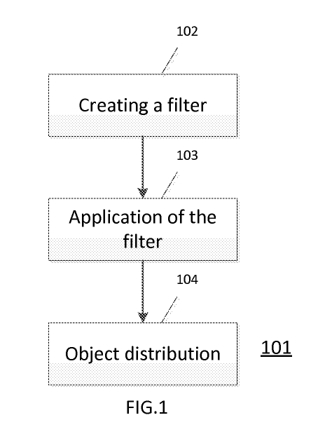

FIG. 1 illustrates the method for customer detection according to some embodiments of the present invention. The method 101 comprises the following steps:
creating, on a first computer system, one or more filters 102. The first computer system can be represented by a desktop computer, laptop, tablet PC, portable multifunction device, cellphone, smartphone, music player, GPS navigator. For purposes of explanation, the term “filter” means an array of one or more objects. In some embodiments of the present invention, the term “geographical filter” will be used. In some embodiments of the present invention, the term “geographical filter” means an array of one or more geographical objects. In some embodiments of the present invention, the geographical filter comprises one or more areas. In some embodiments of the present invention, the area can be set by absolute coordinates. In some embodiments, the area can be set using GPS coordinates or a like system, for example, GLONASS. In some embodiments of the present invention, the area can be set using relative coordinates. In some embodiments of the present invention, the area can be set by a user of the one or more computer systems with one or more programs launched. In some embodiments of the present invention, the one or more programs comprise a graphical user interface with a map where a user of the one or more computer systems can select one or more areas and add it to the filter. In some embodiments of the present invention, the one or more programs comprise means for input coordinates of the area, or title of the place, or address of the area or company name. In some embodiments of the present invention, the filter comprises a set of one or more geographical objects. In some embodiments of the present invention, the filter comprises a set of one or more geographical objects along with a parameter that indicates a radius. This parameter might be applied to part or all geographical objects in the set and used for covering an area around the geographical object;
application of the one or more filters 103 to the one or more objects. In some embodiments of the present invention, one or more filters can be applied to one object. In some embodiments of the present invention, one filter can be applied to one or more objects. In some embodiments of the present invention, the object can be represented in the form of a promo-campaign. For purposes of explanation, the term “promo-campaign” means an offer for one or more goods and/or services promotion. Typically, a promo-campaign comprises information about sale conditions, discounts and geographical location of the place where the potential customer can purchase one or more goods and/or services. However, the present invention is not limited to typically used promo-campaigns and can be used with any possible promo-campaign. In some embodiments of the present invention, the object can be represented in the form of an offer. For purposes of explanation, the term “offer” means information about one or more goods and/or services and purchasing conditions. In some embodiments of the present invention, the object can be represented in the form of one or more links. In some embodiments of the present invention, the link comprises an address to the one or more websites. In some embodiments of the present invention, the link comprises one or more e-mail addresses. In some embodiments of the present invention, the link comprises an iTunes® address to the one or more software applications, or games, or pass-cards, or coupons. In some embodiments of the present invention, the link comprises a Google Play® address to the one or more software applications, or games, or coupons;
one or more objects, having one or more filters, distribution 104. In some embodiments of the present invention, both the one or more objects with the one or more filters that were applied on the previous step, and one or more objects with one or more filters that were applied at the moment of part or whole object creation, are subject for the distribution. In some embodiments of the present invention, only one or more objects with the one or more filters that were assigned on the previous step will be distributed. In some embodiments of the present invention, in case of error in distribution, the one or more objects with the one or more filters will not be distributed. In some embodiments of the present invention, in case only part of the filters raise one or more errors, the one or more objects having one or more filters applied, including those that raise an error in the distribution process, will be distributed only to those objects that don't raise one or more errors. Additionally, in some embodiments of the present invention, in case one or more objects from the one or more filters raise one or more errors in the distribution process, the one or more objects having one or more filters applied, including those that comprise one or more objects that raise one or more errors in the delivery process, will be distributed in accordance with the filter with the exception of those objects in the filter that raise one or more errors in the distribution process. In some embodiments of the present invention, the one or more errors raised in the distribution and/or creating process, which have an informative nature, for example, an error that notifies that there are one or more potential vulnerabilities and, therefore, don't affect the creation and/or distribution process. This means that one or more objects with one or more filters that raise one or more above-mentioned errors with informative nature, will be delivered and/or distributed with accordance to the one or more elements from the one or more filters as it will be delivered and/or distributed in case of no error with informative nature raised while in the distribution and/or creation process. According to the present invention, the object can be represented by one or a combination of the following elements: promo-campaign; advertisement; image; text; sound record; video record; SMS; EMS; MMS; web page; script; personal information; public information; payment information; coupon; credit card information; news; private information; book; magazine; journal; weather; protocol; request; CAD drawing; contract; legal document; hotel check-in and/or check-out information; taxi order; order; bill; government form; beauty shop information; beauty shop request; beauty shop order. Distribution and/or delivery of the one or more objects can be implemented immediately and/or after a period of time that has been set preliminarily by one or more users manually and/or automatically or by one or more computer systems automatically. In some embodiments of the present invention, one part of the objects can be distributed immediately after filter application, another part after the period of time that was set preliminarily.

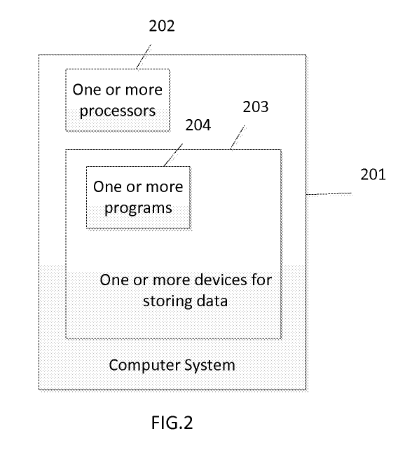

FIG. 2 illustrates the system that implements the method shown in FIG. 1, according to some embodiments of the present invention. The computer system 201 comprises at least one or more processors 202 and one or more devices for storing data 203. The one or more devices for storing data 203 comprise at least one or more programs 204, which can be executed by the one or more processors 202. The one or more programs 204 comprise instructions for:
creation of one or more filters;
application of the one or more filters to one or more objects;
distribution of the one or more objects in accordance with the filters.

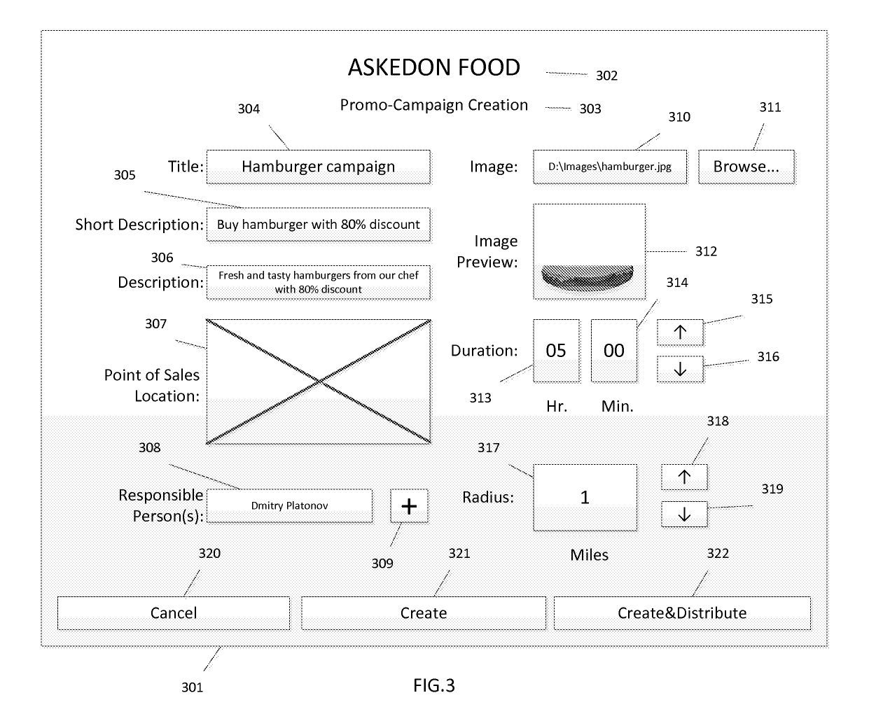

FIG. 3 illustrates the graphical user interface of promo-campaign creation according to some embodiments of the present invention. In this exemplary embodiment, the object is represented by a promo-campaign. The filter is represented by a geographical coordinate of the point of sale location and by a radius parameter, which defines an area (in this exemplary embodiment—a circle) around the geographical coordinate of the point of sale location. The Graphical User Interface (GUI) 301 comprises the following elements:
the brand name of the company and/or software application 302 which implements the present invention. In this exemplary embodiment, the brand name of the software application is “ASKEDON FOOD.” In some embodiments, the GUI 301 does not comprise the element 302. In some embodiments of the present invention, the element 302 comprises one or combination of the following elements: text, image, sound record, video record, link.
the title of the operation 303. In this exemplary embodiment of the present invention, the GUI 301 is used to create a new promo-campaign for a food restaurant and/or coffee shop. This is why the element 303 has the title: “Promo-Campaign Creation.” In some embodiments, the GUI 301 does not comprise the element 303. In some embodiments of the present invention, the element 303 comprises one or more combinations of the following elements: text, image, sound record, video record, link.
the title of the promo-campaign 304. In this exemplary embodiment, the title comprises only text. In some embodiments of the present invention, the title comprises text, images, sound and video record;
the short description of the promo-campaign 305. In this exemplary embodiment, the short description is limited to 140 characters. In some embodiments of the present invention, the short description does not have any size limitation. In some embodiments of the present invention, the short description 305 comprises one or combination of the following elements: text, graphical image, sound record, video record, link, web link, link to iTunes® store;
the description 306. In this exemplary embodiment, the element 306 is similar to element 305 with the exception of character limitation—there is no limitation in size (amount of characters) of the element 306. However, in some embodiments of the present invention, the GUI 301 does not comprise the field 306 at all as the present invention can reach the declared technical result without the element 306;
the means for choosing the geographical location 307. In this exemplary embodiment, the element 307 is represented by a map (for example, Google® Map), where one or more users of the computer system on which GUI 301 is running can find the exact location of the point of sale and mark it. Marking (or choosing) of the geographical location using element 307 means getting the geographical coordinates for the chosen place on the map. In some embodiments of the present invention, the means for choosing the geographical location is represented by not only the map of the city and/or other outside area, but also by an inside map. In terms of the present invention, the “inside map” means a map of the interior of the building. For example, the inside map of the shopping mall shows the location of shops and allows the user to make a route from one place to another. In some embodiments of the present invention, the user of the computer system on which the GUI 301 is running can choose two or more points of sale location where the promo-campaign will be distributed and available. In some embodiments of the present invention, each chosen geographical location of the point of sale has an individual radius parameter. For example, a point of sale on a street normally has a one mile radius around it. This means that the promo-campaign is only visible for people who are physically located in this designated area. If the point of sale is located in a mall, then typically the radius parameter is reduced to 0.1-0.2 miles, because of the large number of messages that can be delivered to potential customers located within the designated area;
the means for choosing responsible person(s) 308. In this exemplary embodiment, the responsible persons are chosen from the list of preliminarily invited one or more persons. In some embodiments, the one or more preliminarily invited persons are employees of the company who have access to the application and/or service. In some embodiments, the one or more software applications and/or services comprise a list of one or more persons who are not employees of the company, who have access to the application and/or service. Typically, such persons are called “freelancers.” The button 309 is used to add additional responsible persons for the promo-campaign management and processing. In some embodiments, the GUI 301 comprises means for responsible persons (managers) management, which functionality comprises, but is not limited to: deleting a manager from the promo-campaign, adding a person to the promo-campaign, editing information about a person, assigning working time, activity management;
the means for choosing and/or assigning the one or more images that will be associated with the promo-campaign. In this exemplary embodiment, these means are represented by text field 310 and button 311, which is used for choosing the one or more images from the computer system. In some embodiments, the GUI 301 comprises the means for choosing and/or assigning the one or more video records. In some embodiments of the present invention, the GUI comprises the means for downloading and/or choosing the image from one or more remote computer systems and/or cloud services (for example, Amazon® Web Services). In this exemplary embodiment, the GUI 301 comprises means for previewing the one or more chosen and/or assigned images 312. In some embodiments, the promo-campaign comprises one GUI. In this situation, the one or more chosen and/or assigned images will be placed to the GUI. If user of the GUI 301 chooses more than one image, then the computer system which shows the promo-campaign to the potential customer will have the means for scrolling the images and/or means for randomly selecting the chosen and/or assigned images, and/or means for changing images periodically (for example, every five seconds). In some embodiments, the one or more images comprise one or more additional elements. In some embodiments, the one or more additional elements are used to get more information about the promo-campaign and/or company that created it. In some embodiments, the one or more additional elements are used for advertisement and/or marketing purposes (for example, location of the point of sale, feedback from customers of the company that created the promo-campaign);
the means for setting a time period of promo-campaign availability. In this exemplary embodiment, the means for setting a time period of promo-campaign availability is represented by the following elements: 313, 314, 315, 316. It should be noted that elements 313, 314, 315, 316 are only one example of the means for setting a time period of promo-campaign availability representation and the present invention should not be limited to only the above-mentioned representation. The elements 315 and 316 are used for correspondingly increasing and decreasing the amount of time of promo-campaign availability. Typically, elements 315 and 316 are buttons, but in some embodiments of the present invention, elements 315 and 316 can be represented by other elements. In some embodiments, the GUI 301 does not comprise elements 315 and 316; and elements 313, 314 are editable. In order to set the time period of promo-campaign availability, the one or more users of the GUI 301 enter information into the fields 313 and 314 directly. In this exemplary embodiment, the GUI 301 comprises only fields for hours (313) and minutes (314). In some embodiments, the GUI 301 comprises one editable field where the user of the GUI 301 can type in the amount of hours of the promo-campaign availability. In this exemplary embodiment, the promo-campaign will become available right after clicking on the button 322. However, in some embodiments of the present invention, the GUI 301 comprises means for setting the date and/or time of promo-campaign start along with duration of promo-campaign availability. For purposes of explanation, the term “duration of promo-campaign availability” means the time period which begins from the start date when the potential customer can see the promo-campaign, interact with it, use it and purchase one or more goods and/or services mentioned in the promo-campaign; the term “active time of the promo-campaign” means the time period which in some embodiments is longer than the duration of promo-campaign, where the potential customer and/or customer can redeem a coupon in the company that created the promo-campaign and in which the potential customer and/or customer participated, and/or read conditions of the promo-campaign and/or purchasing and/or redeeming of the coupon and/or code generated by the one or more programs.
the means for area designation. In this exemplary embodiment, the means for area designation is represented by elements 317, 318, 319. For purposes of explanation, “the area of designation” or “designated area” or “chosen are” means the one or more geographical areas where the one or more promo-campaigns are available. It should be noted that in some embodiments of the present invention, the promo-campaign will not be visible for users of computer systems that are located outside the chosen area. In some embodiments of the present invention, the user of the computer system specifies one or more geographical locations where he wants to get information about advertisement and/or promo-campaign and/or events and/or special events. By clicking on the buttons 318 or 319, the user of the computer system that shows the GUI 301 changes the radius of the designated area for the promo-campaign. For purposes of explanation, the term “promo-campaign” means a promo-campaign and/or an event and/or a special event and/or an advertisement. In some embodiments of the present invention, the user can choose the exact area where the promo-campaign should be available by clicking on the map and drawing the area on it. In some embodiments, the means for area designation is represented by one or more text fields. By using the above-mentioned one or more text fields, the user of the computer system that shows the GUI 301 inputs the coordinates of places where the promo-campaign will be available. The availability of the promo-campaign, in terms of the present invention, means that one or more users with one or more computer systems that are geographically located within the designated area for the promo-campaign, will be able to see and/or review and/or send one or more messages and/or purchase one or more goods and/or services mentioned in the promo-campaign. If there are no computer systems within the designated area, then nobody will see it. However, in some embodiments of the present invention, the one or more users of the one or more computer systems can set the location where one or more users want to see and/or review and/or send a message and/or purchase one or more goods and/or services mentioned in the promo-campaign. But when the one or more users with one or more computer systems enter the designated area, they will immediately be able to see and/or review and/or send a message and/or purchase one or more goods and/or services mentioned in the promo-campaign. Accordingly, when one or more users leave the area designated for the promo-campaign, the promo-campaign will disappear from the one or more computer systems of one or more users who left the designated area for promo-campaign, unless the one or more have already begun browsing and/or reviewing the promo-campaign, chatting with the promo-campaign's one or more representative persons and/or purchasing goods and/or services mentioned in the promo-campaign;
the management buttons. In this exemplary embodiment, the management buttons are represented by buttons 320, 321 and 322. In terms of the present invention, the “management button” represents means for changing the status of the one or more promo-campaigns, for example, changing the status from “draft” to “work,” which, in this exemplary embodiment, can be made by clicking on the button 322 “Create & Distribute.” Additionally, in this exemplary embodiment, the user can change the status of the promo-campaign from “draft” to “new, not distributed” by clicking on the button 321. It should be noted that the titles of all statuses are used only for explanation purposes. The button 320, in this exemplary embodiment, is used for cancelling the operation of the promo-campaign creation. The button 321, in this exemplary embodiment, is used to change the status of the promo-campaign from “draft” to “created.” It should be mentioned that before the GUI 301 appears, the one or more users of the one or more computer systems sent a command to the one or more computer systems for one or more promo-campaign creation, for example, by clicking on the button “create a new promo-campaign” (not shown on FIG. 3) or by touching a touch-sensitive display. It should be mentioned that the present invention should not be limited to the methods of sending one or more commands for the one or more promo-campaign creations mentioned above.

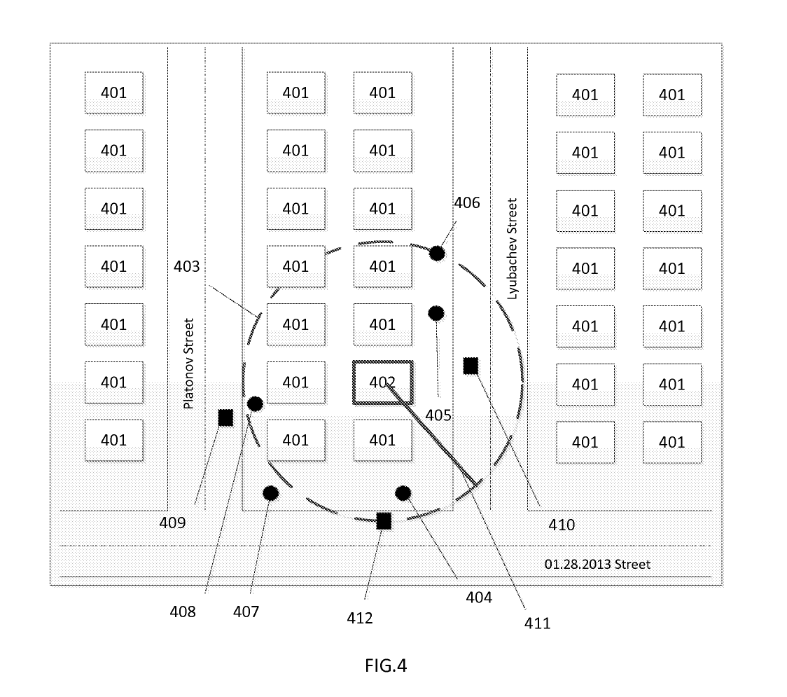

FIG. 4 illustrates one of the embodiments of the present invention. FIG. 4 comprises a part of the map of the city. The element 402 represents the point of sale of the company whose one or more employees have successfully created and distributed the promo-campaign for point of sale 402 promotion and/or goods and/or services that can be purchased at the point of sale 402 promotion. The circle 403 represents the area of designation. The one or more users with one or more means for promo-campaign receiving, viewing and interaction, for example computer systems, within the area marked by the circle 403, will be able to receive and participate in the promo-campaign. In this exemplary embodiment, the following persons will be able to receive, view details of the promo-campaign, send one or more messages to the person responsible for the promo-campaign and/or participate in the promo-campaign and/or purchase one or more goods and/or services mentioned in the promo-campaign and/or promoted by a promo-campaign representative and/or one or more other persons who have the ability and rights to offer goods and/or services to the potential customers and/or customers: 408, 405, 404 and person in car 410. In this exemplary embodiment, the following persons will not be able to receive, view details of the promo-campaign, send one or more messages to the person responsible for the promo-campaign and/or participate in the promo-campaign and/or purchase one or more goods and/or services mentioned in the promo-campaign and/or promoted by a promo-campaign representative and/or one or more other persons who have the ability and rights to offer goods and/or services to the potential customers and/or customers: 407, 406, persons in car 409, 412, unless:
the above-mentioned persons were located within the area designated by circle 403 in the previous moments in time when the promo-campaign was available for all users with one or more computer systems located within the area designated by circle 403; and
the users 406, 407, 409 and 412 opened the promo-campaign and/or sent one or more messages to the one or more persons responsible for the promo-campaign and/or purchased one or more goods and/or services mentioned in the promo-campaign and/or promoted by a promo-campaign representative and/or one or more other persons who have the ability and rights to offer goods and/or services to the potential customers and/or customers.

In some embodiments of the present invention, the radius 411 of the circle 403 which designates the area where one or more promo-campaigns will be available, can be changed by the one or more persons who create a new promo-campaign. Additionally, in some embodiments of the present invention, the radius 411 of the circle 403 which designates the area where one or more promo-campaigns will be available, can be changed by the one or more persons who have rights to do so, on-the-fly, i.e., when one or more promo-campaigns are available. It can be done in the following situations:
1 the radius 411 of the circle 403 is very small for the particular one or more promo-campaigns which are available within part or all of the designated area. For purposes of explanation, the term “small designated area” or “small radius of circle” means the area where a small amount of potential customers and/or customers are be able to review and/or send one or more messages to the one or more promo-campaign representative and/or one or more other persons who have the ability and rights to offer goods and/or services to the potential customers and/or customers and act of behalf of one or more organizations and/or companies to which the one or more point of sale belongs and/or which have rented the one or more points of sale mentioned in the promo-campaign. “Small amount of customers” is a very specific term and it is determined in each case individually. It should be noted that the present invention should not be limited to the specific numbers of the terms “small amount of customers” and/or “small area” and/or “small radius of circle.” In this exemplary embodiment, it is presumed that one or more organizations and/or companies to which the one or more points of sale belong and/or which have rented the one or more points of sale mentioned in the promo-campaign already determined in percents and/or numbers corresponding to and/or describing the “small amount of customers” and/or “small radius of circle” and/or “small area” and the current numbers and/or percents are equal or smaller preliminarily determined amounts and/or percents. For example, the above-mentioned situation can appear when the manager of the one or more points of sale is not satisfied with the amount of people who opened and/or purchased the goods and/or services mentioned in the promo-campaign. So, in this case, the area can be increased by increasing the radius parameter. In this exemplary embodiment, the area can be increased by one or combination of the following ways:
   a manually by one or more users of the one or more computer systems and/or one or more remote computer systems which have the means for changing promo-campaign parameters directly or indirectly, by changing one or more parameters responsible directly and/or indirectly for the area size of the one or more promo-campaigns;
   b automatically by one or more computer systems and/or one or more remote computer systems which have the means for changing promo-campaign parameters directly or indirectly, for example, by comparing preliminarily defined one or more parameters, which indicate and/or define “small amount of customers” with current parameters of the available promo-campaign.
2 the radius 411 of the circle 403 is very big for the particular one or more promo-campaigns which are available within part or all designated area. For purposes of explanation, the term “big designated area” or “big radius of circle” means the area where a large amount of potential customers and/or customers will be able to review and/or send one or more messages to the one or more promo-campaign representatives and/or one or more other persons who have the ability and rights to offer goods and/or services to the potential customers and/or customers and act on behalf of one or more organizations and/or companies to which the one or more point of sale belongs and/or which have rented the one or more point of sale mentioned in the promo-campaign. “Large amount of customers” is a very specific term and it is determined in each case individually. It should be noted that the present invention should not be limited to the specific numbers of the terms “big amount of customers” and/or “big area” and/or “big radius of circle.” In this exemplary embodiment, it is presumed that one or more organizations and/or companies to which the one or more points of sale belongs and/or which have rented the one or more points of sale mentioned in the promo-campaign already determined in percents and/or numbers corresponding to and/or describing the term “big amount of customers” and/or “big radius of circle” and/or “big area” and the current numbers and/or percents are equal to or bigger than preliminarily determined amounts and/or percents, corresponding to and/or describing one or more parameters and/or terms which affect directly and/or indirectly the characteristics determined by the one or more above-mentioned terms. For example, the above-mentioned situation can arise when the amount of people who opened and/or purchased the goods and/or services mentioned in the promo-campaign is very big and one or more points of sale are not able to service all customers who want to purchase one or more goods and/or services sold by the company which created the one or more promo-campaigns or sent a request to third party one or more companies to create one or more promo-campaigns. So, in this case, the area can be decreased by decreasing the radius parameter. In this exemplary embodiment, the area can be decreased by one or a combination of the following:
   a manually by one or more users of the one or more computer systems and/or one or more remote computer systems which have the means for changing promo-campaign parameters directly or indirectly by changing one or more parameters that are responsible directly and/or indirectly for the area size of the one or more promo-campaigns;
   b automatically by one or more computer systems and/or one or more remote computer systems which have the means for changing promo-campaign parameters directly or indirectly, for example, by comparing preliminarily defined one or more parameters which indicate and/or define “big amount of customers” with current parameters, responsible directly and/or indirectly for the area size of the available promo-campaign.

In this exemplary embodiment, the present invention works in the following way: The one or more employees of the point of sale 402 and/or one or more persons who have rights to create one or more promo-campaigns for point of sale 402 (for purposes of explanation, such persons will be called “creating person”), create one or more promo-campaigns for the point of sale 402 and set the radius 411 with the center in the point of sale 402, where the one or more promo-campaigns have been planned to be available. Optionally, the one or more creating persons can set the time period and the date when the one or more new promo-campaigns will be available. After all the promo-campaign parameters are set, for example, those that are displayed in the GUI 301, the one or more creating persons submit the promo-campaign. If date and time were explicitly set, then the newly created promo-campaign will remain idle until the date and time which were explicitly set during the promo-campaign creation. If date and time were not explicitly set, then the newly created promo-campaign will be published and/or distributed immediately. When one or more persons enter the designated area (in this exemplary embodiment, the designated area is circle with radius 411 and center in the point of sale 402), while the promo-campaign is available and request one or more promo-campaigns, then such persons will be able to see, review, ask one or more questions (for example, by using an invention described in the U.S. patent application Ser. No. 13/689,763 filed Nov. 30,2012, entitled “System and method of interaction,” first named inventor: “Mikhail Leonidovich Liubachev”), purchase one or more goods and/or services (for example, by using an invention described in the U.S. patent application Ser. No. 13/680,123 filed Nov. 19, 2012 entitled “System and method for goods and services promotion”, first named inventor: “Mikhail Leonidovich Liubachev”), mentioned in the promo-campaign and/or promoted by one or more salespersons of the point of sale 402 and/or other goods and/or services related to the one or more companies which create the one or more promo-campaigns. If, while interacting with one or more promo-campaigns, the one or more users with one or more means for interacting with one or more promo-campaigns leave the designated area, the promo-campaign will be available for one or more users until the one or more users close one or more promo-campaigns. After closing one or more promo-campaigns (in some embodiments of the present invention, closing one or more promo-campaigns is made in the form of “back” button), the one or more users with one or more means for interacting with one or more promo-campaigns will be able to see and/or interact with those one or more promo-campaigns which are available at the geographical location of the one or more users with one or more means for interacting with one or more promo-campaigns. If one or more users purchased one or more goods and/or services mentioned in the promo-campaign and/or promoted by one or more salespersons of the point of sale 402 and/or other goods and/or services related to the one or more companies which created the one or more promo-campaigns, the information about purchase is saved to the one or more storage of the one or more computer systems which have the means to interact with one or more computer systems of the one or more companies which created and/or used the one or more promo-campaigns. In some embodiments of the present invention, the information about purchase is saved to the one or more computer systems on which the purchase and/or request for purchase was made. In some embodiments of the present invention, the information about purchase comprises one or a combination of the following elements:
identification of the one or more computer systems from which the purchase was made;
identification of the one or more users of the one or more computer systems;
terms of the purchase;
conditions of the purchase;
list of the purchased goods and/or services;
categories of the purchased goods and/or services;
geographical location from which the purchase was made;
one or more geographical locations, indicating the path of the one or more users' movement during interaction with one or more promo-campaigns;
one or more actions which were made by the one or more users during the interaction with one or more promo-campaigns;
one or more actions which were made by the one or more representatives of the one or more companies during communication with one or more users;
information about previous purchases of the one or more users;
information about bonus points and/or money balance;
information about one or more friends of the one or more users;
information about one or more friends of the friends of the one or more users.

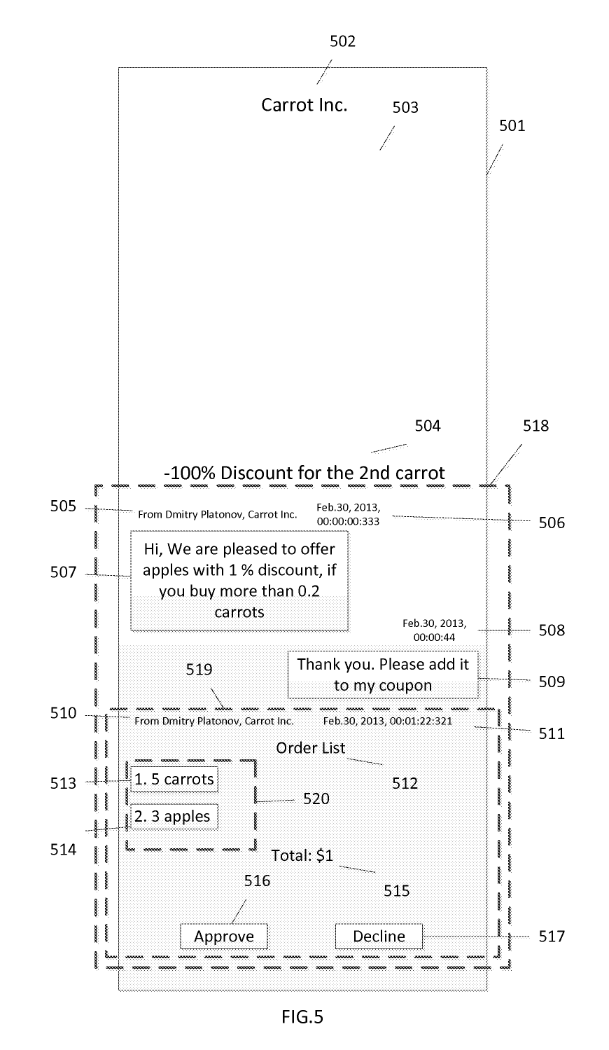

FIG. 5 illustrates the description of the promo-campaign according to some embodiments of the present invention. According to some embodiments of the present invention, the GUI 501 comprises the following elements:
the title of the company 502 which sells the products mentioned in the promo-campaign;
the image 503 associated with the promo-campaign;
the brief description 504 of the promo-campaign;
block of interaction 518, which is used for interaction between a company representative or salesperson with the potential customer. The block of interaction comprises the following elements:
   the company representative or salesperson's full name and company name 505;
   time stamp (date and time) 506 of message delivery;
   the message 507 from the company representative or salesperson. In this exemplary embodiment, the message 507 comprises additional promotion of goods and/or services which company 502 sells to customers;
   time stamp 508 of reply delivery prepared by the user of the computer system on which the GUI 501 is running;
   the reply 509, prepared by the user of the computer system, on which the GUI 501 is running. In some embodiments of the present invention, the one or more replies are prepared by one or more persons who have the means to establish a network connection to one or more computer systems which have one or more programs executed on one or more processors and stored in the one or more devices for storing data, with instructions and/or commands for sending a reply to one or more computer systems which have the means for receiving replies from one or more computer systems and to which one or more potential and/or existing customers have an access;
   the order confirmation section 519, which, in this exemplary embodiment, comprises the following elements:
      the full name of the sales manager and company title 510. It should be noted that in some embodiments of the present invention, the element 510 comprises one or more full names of the sales managers. In some embodiments of the present invention, the element 510 comprises one or more full names of the persons who are responsible for communication with customers and potential customers, and one or more companies' identification information;
      the information about date and/or time of the message delivery 511. In this exemplary embodiment, the element 511 comprises the date and time when one or more messages were received at one or more computer systems which show the GUI 501. In some embodiments of the present invention, the element 511 comprises only time of the delivery;
      the title of the receipt 512;
      the list of purchased goods and/or services 520 which comprises the product 513 and product 514. In some embodiments of the present invention, the list of purchased goods and/or services comprises one or more goods and/or services. In some embodiments of the present invention, the list of the goods and/or services comprises one or a combination of the following elements: title of the goods and/or services, amount of goods and/or services, price of the one item of goods and/or one service, total price of all goods and/or services as stated in the list 520, information about taxes, discount rate of each product, total discount rate of goods and/or services as stated in the list 520, contact information of the one or more company representative, means for payment, means for receiving information about payment, means for adding additional goods and/or services, means for editing the contents of the list 520;
      the means for one or more orders confirmation. In this exemplary embodiment, the means for one or more orders confirmation is represented by the button “Approve” 516. In some embodiments of the present invention, the means for order confirmation is represented by one or more graphical elements which are used for payment for the order;
      the means for one or more orders termination. In this exemplary embodiment, the means for one or more orders termination is represented by button “Decline” 517. In some embodiments of the present invention, the one or more orders are terminated after some period of time, for example, 5 minutes, started from one or more orders delivery to the one or more users.

In some embodiments of the present invention, the user will be hidden to the one or more promo-campaign representatives until the reply 509 is sent. In some embodiments of the present invention, in order to avoid spam, the one or more users of the one or more computer systems are invisible by default. If the one or more users of the one or more computer systems want to receive one or more offers from the one or more companies, they can mark themselves as visible on the map. By changing the state from the invisible to visible, the one or more computer systems become visible for one or more companies. The one or more employees of the one or more companies can immediately begin interaction with the one or more users of the one or more computer systems that became visible. It should be mentioned that in some embodiments of the present invention, the terms “visible,” “invisible,” “visible mark,” “invisible mark,” “visible state,” “invisible state” have other titles.

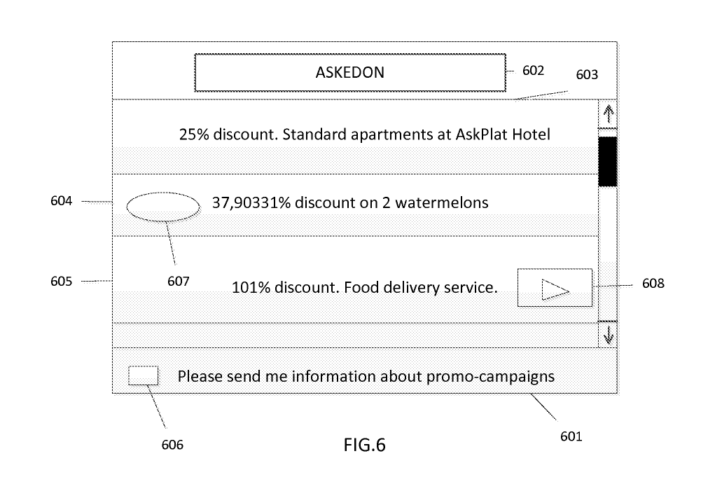

FIG. 6 shows the graphical user interface according to some embodiments of the present invention. FIG. 6 illustrates a graphical user interface (GUI) 601, which comprises the following elements:
the title of the application 602. In some embodiments of the present invention, the title of the application has graphical and/or sound and/or video elements. In some embodiments of the present invention, if the title contains more characters than can be displayed on the top of the GUI 601, then one or more software applications cut the last part of the title 602 and replace the cut characters with, for example, “ . . . ” characters. In case of graphical elements in some embodiments of the present invention, the size of one or more images is adjusted to fit the space designated for the title 602;
the first advertisement 603, which comprises a link to the part or full promo-campaign description. In this exemplary embodiment, the first advertisement 603 comprises part of promo-campaign description, as follows: discount rate and information about apartments at AskPlat Hotel. It should be noted that in some embodiments of the present invention, the first advertisement 603 comprises another element related to the promo-campaign description and/or terms;
the second advertisement 604. In this exemplary embodiment, the second advertisement 604 comprises the following elements related to the advertisement description: an ellipse 607, which represents graphical information about one or more products and/or services related to the promo-campaign, a very precise discount rate, and part of the terms of the advertisement;
the third advertisement 605. In this exemplary embodiment, the third advertisement 605 comprises the following elements related to the advertisement description: a discount rate, part of the service description and video record 608;
the check-box and description of the check-box 606. In this exemplary embodiment, if a user clicks or taps on the check-box, the one or more programs change the state of the check-box to the “checked” status (check appears in the check-box) and the user of the one or more computer system becomes visible to the one or more employees of the nearby point of sale and/or companies which rent or own the one or more nearby points of sale. In some embodiments of the present invention, if the one or more users appear on the map of the one or more sales managers and/or other one or more companies representatives who have means to create, control and/or manage the one or more promo-campaigns, these employees, as stated above, can get additional information about the one or more users who are shown on the map, send one or more messages to the one or more users who are shown on the map, change the offer mentioned in the promo-campaign. In some embodiments of the present invention, after the one or more users clicked and/or tapped on the 606 check-box, the one or more programs which comprise one or more commands which when executed on the or more processors, displays the GUI 601, can change the GUI 601 and add a list of the one or more messages and/or offers and associated promo-campaigns. In this exemplary embodiment, the list is sorted by time, which means that the most recent proposal will appear on top of the list. In some embodiments of the present invention, the message which appears in the list is represented by one or a combination of the following elements:
   text;
   image;
   one or more special characters;
   sound record;
   video record;
   bill;
   terms of the promo-campaign;
   conditions of the promo-campaign;
   contact information;
   time period of the promo-campaign availability;
   time period of the code availability;
   full name of the representative of the company which sells the one or more goods and/or services mentioned in the one or more promo-campaign;
   one or more elements for payment;
   status of the advertisement;
   path to the one or more points of sale;
   amount of people who have already accepted and/or reviewed part or full promo-campaign description;
   amount of customers who are located near the one or more users;
   address of the one or more points of sale;
   link to the one or more Internet resources.

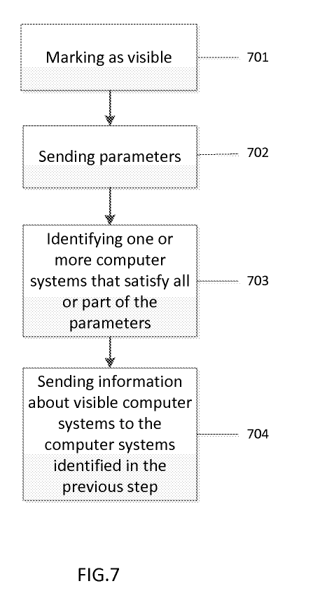

FIG. 7 shows the method of changing the state of the user according to some embodiments of the present invention. According to FIG. 7, when one or more users change the state of visibility to one or more representatives of the one or more companies, the one or more systems perform the following actions:
a portable multifunction device receives one or more requests from the one or more users of the portable multifunction device to change the state to Visible 701. In this exemplary embodiment, the one or more users of the portable multifunction device click on the check-box 606 in order to change the state to Visible. In some embodiments of the present invention, the one or more users change the state to Visible by sending one or more voice commands to the speech recognition module of the portable multifunction device and/or to the one or more speech recognition systems including remote speech recognition systems. In some embodiments of the present invention, the one or more users change the state to Visible by using one or more gestures. In some embodiments of the present invention, the gestures can be inputted to the gesture recognition module of the portable multifunction device, for example, a touch-screen. In some embodiments of the present invention, information about one or more gestures is sent to the one or more computer systems which have means for gesture recognition. In some embodiments of the present invention, the state is changed automatically by a portable multifunction device, for example, after a period of time and/or upon reaching a specific geographical location;
sending one or more parameters 702, from the portable multifunction device, to the one or more computer systems. In this exemplary embodiment, the portable multifunction device sends the following parameters: the information about current geographical location of the portable multifunction device and/or the one or more users of the portable multifunction device; the identification information of the portable multifunction device and/or the one or more users of the portable multifunction device. In some embodiments of the present invention, the portable multifunction device sends one or combination of the following elements:
   one or more users' authentication information;
   one or more images associated with the portable multifunction device;
   one or more images associated with the one or more users of the portable multifunction device;
   one or more video records associated with the portable multifunction device;
   one or more video records associated with the one or more users of the portable multifunction device;
   one or more sound records associated with the portable multifunction device;
   one or more sound records associated with the one or more users of the portable multifunction device;
   geographical location of the portable multifunction device;
   geographical location of the one or more users of the portable multifunction device;
   one or more geographical locations of the portable multifunction device and/or one or more users of the portable multifunction device which was determined before sending one or more parameters;
   information about friends and/or friends of the friends of the one or more users of the portable multifunction device;
   information about payment methods which is registered in the one or more applications to which the portable multifunction device has access;
   information about one or more goods and/or services which were purchased before sending one or more parameters;
   text;
   price requirements;
   discount requirements;
   one or more promotional messages;
   terms and/or conditions of the offer.
upon receiving at the one or more computer systems, the one or more parameters, the one or more computer systems compares the one or more parameters which were received with one or more parameters of the one or more promo-campaigns and/or one or more points of sale.
If part or all received parameters are equal to the part or all and/or in the preliminary determined range of the one or more promo-campaigns and/or points of sale parameters, the one or more points of sale representatives who have access to the one or more promo-campaigns which parameters are equal to the part or all and/or in the preliminarily determined range of the one or more promo-campaigns and/or points of sales parameters, will be able to see the one or more users of the portable device as persons who wish to receive one or more offers. Such one or more promo-campaigns and/or points of sale are considered, according to some embodiments of the present invention, as a place near the one or more users of the portable device. In all other situations, according to some embodiments of the present invention, the one or more points of sale representatives will not see information about one or more persons who wish to receive one or more offers as all other points of sale are considered as places which are located far from the current geographical location of the one or more users of the portable multifunction device.
After the nearest one or more points of sale, to the one or more users of the portable multifunction device, are identified, the one or more computer systems “connects” the portable multifunction device with the one or more nearest points of sale representatives who have access to the one or more promo-campaigns which applied to at least one of the nearest, to the one or more users of the portable multifunction device, points of sale by sending 704 information about one or more users of the portable multifunction device who wished to receive one or more offers, and/or the portable multifunction device to the one or more computer systems of the one or more representatives of the one or more points of sale and/or promo-campaigns. In some embodiments of the present invention, the information could be sent to the one or more computer systems to which the one or more representatives of the one or more points of sale and/or promo-campaigns have access.

It should be mentioned that the point of sale representative and/or promo-campaign representative (in some embodiments, it is the same person) can be located not only at the point of sale, but also anywhere in the world. Additionally, in some embodiments of the present invention, one or more computer systems which have launched one or more promo-campaigns, could be located not only at the point of sale, but also anywhere in the world. In some embodiments of the present invention, one or more computer systems which have means for promo-campaigns management and means for establishing a network connection with one or more other computer systems, connects to the one or more computer systems which have launched the one or more promo-campaigns. In some embodiments of the present invention, one or more computer systems which have launched one or more promo-campaigns additionally have means for one or more promo campaign management and vice versa. Also, it should be mentioned, according to some embodiments of the present invention, one or more persons can have access to the one or more promo-campaigns and/or points of sale.

In some embodiments of the present invention, after one or more places nearest to the one or more users of the portable multifunction device are identified, the one or more users of the portable multifunction device receive information about one or more promo-campaigns which correspond to the nearest one or more places and/or points of sale and/or shops and/or places.

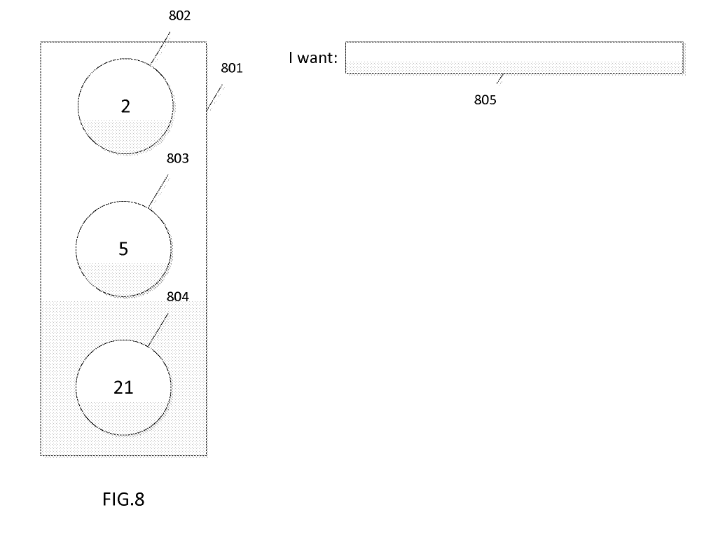

In some embodiments of the present invention, one or more users of the one or more portable multifunction devices have one or more choices regarding visibility for the one or more companies and/or persons who wished to communicate about and/or promote one or more goods and/or services. FIG. 8 shows GUI 801 (however, in some embodiments of the present invention, the one or more portable multifunction devices comprise one or more GUIs, which comprises GUI 801), which comprises the following elements:
the first circle 802, which indicates that there are two offers from the nearest one or more places and/or points of sale. Typically, in some embodiments of the present invention, before receiving offers and/or messages from the nearest one or more places and/or points of sale and/or persons, the one or more users of the one or more portable multifunction devices should mark themselves as visible for one or more persons and/or representatives of the one or more points of sale and/or places. By default, typically, all users are marked invisible in order to avoid spam. However, in some embodiments of the present invention, the one or more users of the one or more portable multifunction device can have the means for changing the default settings for visibility. According to some embodiments of the present invention, if one or more users of the one or more portable multifunction device want to choose the visibility and begin to receive one or more messages and/or offers from the one or more nearest persons and/or representatives of the nearest one or more points of sale and/or places, the one or more users of the one or more portable multifunction devices need to click on the first circle 802 and identify what the one or more users and/or other persons (In some embodiments of the present invention, the one or more users of the one or more portable multifunction devices and/or computer systems can search for goods and/or services and/or messages, for example, for their friends, wives, husbands, babies. In some embodiments of the present invention, friends and/or relatives of the one or more users of the one or more portable multifunction device also become the users of the one or more portable multifunction devices) want. For example, if the user wants to buy snacks at the nearest shop, he needs to click on the first circle 802 and input the following string to the text field 805 with title “I want”: “I want snacks,” or “I want to buy snacks for 0.5 USD.” Typically, the text field 805 appears near the circle 802 after interaction, for example, after one or more users of the one or more portable multifunction devices clicks on the first circle 802. In some embodiments of the present invention, after interaction with the first circle 802, the one or more software applications change the GUI which comprises only the element 805. In some embodiments of the present invention, the element 805 additionally comprises the means to submit wishes to the one or more persons and/or representatives of the one or more points of sale and/or shops. Typically, according to some embodiments of the present invention, the means for submitting wishes is represented by a button. In some embodiments of the present invention, the means for submitting wishes is invisible to the one or more users of the one or more portable multifunction devices, and this means is activated by one or more events that appear on the one or more portable multifunction devices and/or computer systems. For example, most of the software applications don't have a submit button, instead, the software application tracks the activity of the user (idle is an activity too) and when, for example, the one or more users of the one or more portable multifunction devices has finished writing one or more wishes to the element 805, the software application submits it automatically.
the second circle 803, which indicates the nearest one or more points of sale and/or shops and/or places and/or persons which published one or more promo-campaigns and in which one or more users of the one or more portable multifunction devices can participate and/or purchase one or more coupons and/or purchase one or more goods and/or services. In some embodiments of the present invention, the one or more nearest points of sale and/or shops and/or places and/or persons don't need to create and submit one or more promo-campaigns to be visible for the nearest one or more users of the one or more portable multifunction devices and/or computer systems. According to said embodiments, the one or more software products which implement part or entire present invention, have one or more instructions to make one or more companies and/or personal accounts visible for any person and/or company within the designated area. In order to designate one or more areas for the one or more companies and/or persons profiles, the one or more persons, which have rights and means for company's profile management, click on the map and/or write the value of the radius parameter. Radius parameter designate the area around the particular point of sale. The means for area designation are similar to those described above.
the third circle 804, which indicates the number of the nearest one or more points of sale and/or shops and/or places and/or persons which have a company and/or personal profiles in the one or more software which implements part or entire present invention. In some embodiments of the present invention, the third circle indicates only those companies and/or persons which have limited access to the one or more software which implements part or entire present invention, for example, companies with limited access can't send and/or reply to the messages from the customers.

In some embodiments of the present invention, the one or more users of the one or more computer systems creates a group and invites other one or more users of the one or more computer systems to join the group. Also, in some embodiments of the present invention, the one or more companies and/or persons creates one or more promo-campaigns for the groups of users and/or one or more promo-campaigns comprises one or more special offers for the group of the users. According to said embodiments, a user of the one or more computer systems who wishes to create a group needs to be located within the designated area of the one or more promo-campaigns (in order to see the promo-campaign, according to some embodiments of the present invention). After choosing the promo-campaign (Even without special offer for the group of the users. It should be mentioned that the present invention should not be limited to the promo-campaigns which have a special offer or which are specially designed for the group of users in which the group of users can participate and/or purchase one or more coupons and/or purchase one or more goods and/or services. The present invention allows, in some embodiments of the present invention, the group of users to participate in any promo-campaign and/or interact with one or more representatives of the one or more points of sale and/or companies.), the user creates a group by inviting other one or more users. It should be mentioned that the group of users comprises two or more users of the one or more computer systems. However, in some embodiments of the present invention, a group of users comprises one or more users of the one or more computer systems. It can happen, for example, after all users left the group except one. After the group was created, the user who created the group interacts with one or more promo-campaigns bound to the nearest one or more points of sale and/or shops and/or companies and/or persons. The group creator purchases one or more coupons and/or one or more goods and/or services corresponding to the one or more promo-campaigns. In some embodiments of the present invention, the group creator has the means to assign one or more roles to the group members. In some embodiments of the present invention, the one or more group members have the means to get information about one or more actions and/or interactions of the group creator and/or other one or more members of the group. In some embodiments of the present invention, the group members have means to interact (for example, ask a question about the promo-campaign and/or company and/or person) and/or purchase one or more coupons and/or goods and/or services. In some embodiments of the present invention, the group creator and/or other group members have the means to review promo-campaigns which are visible within the area where at least one of the group members is located.

Big cities have a very complicated traffic organizing system, for example, in some cities, the car driver needs, in order to get to the shop, located within 50 meters of the car's driver current geographical location, to ride for more than one kilometer, because of the traffic system. So, in some embodiments of the present invention, the term “radius”, which is used to designate area around one or more points of sales, means a set of one or more paths from one or more places to the one or more points of sales, with the value not more than the value of the radius. If the value of the path from the current geographical location to the one or more points of sales, to which one or more promo-campaigns are applied, with the specific radius parameter value, will be equal or less than the value of radius, the car's driver will be able to see above-mentioned one or more promo-campaigns.

Disclaimer. The example companies, organizations, products, people, places, and events depicted herein are fictitious. No association with any real company, organization, product, person, places, or events is intended or should be inferred.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method for a customer involvement, comprising:
a. creating or obtaining from one or more external sources, on a first computer system, a one or more parameters dependent filter for further promo-campaign distribution, wherein the one or more parameters dependent filter comprises one or more parameters;
b. linkage, on the first computer system, of the created one or more parameters dependent filter with one or more preliminary created promo-campaigns; wherein the promo-campaign comprising an advertising and/or promotion information about one or more goods and/or services;
c. distributing the one or more promo-campaigns associated with linked set of parameters from the one or more parameters dependent filter to the one or more computer systems, which correspond with set of the parameters listed in the one or more parameters dependent filter.

2. The method of claim 1, wherein the linkage is made by one or combination of the following methods:
a. by adding, to the promo-campaign, one or more files, corresponding to the one or more parameters dependent filter;
b. by adding information, corresponding to the one or more parameters dependent filter, to the one or more files, corresponding to the promo-campaign.

3. The method of claim 1, wherein the distribution is made by transferring the information, corresponding to the promo-campaign from the first computer system to the one or more computer systems.

4. The method of claim 1, wherein the distribution is made by providing access to the promo-campaign, stored in the first computer system, to the one or more computer systems.

5. The method of claim 1, wherein the distribution is made by providing access to one part of the promo-campaign, stored in the first computer system, to the one or more computer systems, wherein the promo-campaign comprises two or more parts; wherein at least one part of the promo-campaign is stored in the first computer system.

6. The method of claim 1, wherein the distribution is made by transferring one part of the promo-campaign, stored in the first computer system, to the one or more computer systems, wherein the promo-campaign comprises two or more parts; wherein at least one part of the promo-campaign is stored in the first computer system.

7. The method of claim 1 further comprising:
a. sending one or more requests, from a first computer system to the one or more computer systems, to identify if all or part of the computer systems, which previously received the one or more promo-campaigns, correspond with set of the parameters listed in the one or more parameters dependent filter;
b. if all or part of the computer systems don't correspond with set of the parameters listed in the one or more parameters dependent filter, the one or more promo-campaigns become unavailable for said all or part of the computer systems.

8. The method of claim 1 further comprising:
a. interacting with the one or more promo-campaigns, on the one or more computer systems, to which the one or more promo-campaigns were distributed;
b. sending a notification about interaction, from the one or more computer systems, to which the one or more promo-campaigns were distributed, to the first computer system; wherein the notification comprises information about interaction and information about one or more parameters listed in the one or more parameters dependent filter;
c. analyzing, at the first computer system, the received notification about interaction;
d. creating a report about interaction, based on performed analysis; wherein the report comprises an information about comparison of received one or more parameters and one or more corresponding parameters listed in the one or more parameters dependent filter.

9. A computer-implemented method for a customer involvement, comprising:
a. creating or obtaining, on a first computer system, one or more promo-campaigns; wherein the promo-campaign comprises an advertising and/or promotion information about one or more goods and/or services and one or more parameters, corresponding to the one or more promo-campaigns distribution;
b. receiving, on the first computer system, one or more parameters from one or more computer systems;
c. distributing the one or more promo-campaigns to the one or more computer systems, If one or more received parameters correspond to one or more parameters of the one or more promo-campaigns.

10. A computer-implemented method for a customer involvement, comprising:
a. creating, on a first computer system, a one or more parameters dependent filter for further promo-campaign distribution, wherein the one or more parameters dependent filter comprises a list of parameters;
b. linkage, on the first computer system, of the created one or more parameters dependent filter with one or more preliminary created promo-campaigns; wherein the promo-campaign comprising an advertising and/or promotion information about one or more goods and/or services;
c. receiving, on the first computer system, the one or more parameters from the one or more computer systems;
d. identifying if one or more received parameters correspond with set of the selected parameters listed in the one or more parameters dependent filter;
e. distributing the one or more promo-campaigns with linked one or more necessary parameters dependent filter to the one or more computer systems, which previously sent the one or more parameters to the first computer system, if one or more received parameters correspond with set of parameters listed in the one or more parameters dependent filter.

11. A computer-implemented method for a customer involvement, comprising:
a. creating or obtaining from one or more external sources, on a first computer system, a one or more parameters dependent filter for further promo-campaign distribution, wherein the one or more parameters dependent filter comprises a list of parameters;
b. linkage, on the first computer system, of the created one or more parameters dependent filter with one or more preliminary created promo-campaigns; wherein the promo-campaign comprising an advertising and/or promotion information about one or more goods and/or services; wherein the one or more promo-campaigns are unavailable for all computer systems, except one or more computer systems, that have means for one or more promo-campaigns management and/or usage, and/or involved one or more computer systems;
c. receiving, on the first computer system, the one or more parameters from the one or more computer systems;
d. identifying if one or more received parameters correspond with set of the parameters listed in the one or more parameters dependent filter;
e. making available one or more promo-campaigns with linked one or more necessary parameters dependent filter to the one or more computer systems, which sent the one or more parameters to the first computer system, if one or more received parameters correspond with set of the parameters listed in the one or more parameters dependent filter.

12. The method of claim 11 further comprising:
a. updating one or more parameters on the one or more computer systems;
b. sending one or more updated parameters from the one or more computer systems to the first computer system;
c. displaying the information about one or more promo-campaigns on the one more computer systems, if one or more updated parameters correspond with set of parameters listed in the one or more parameters dependent filter.

13. A computer-implemented method for a customer involvement, comprising:
a. creating or obtaining from one or more external sources, on a first computer system, a one or more parameters dependent filter for further promo-campaign distribution, wherein the one or more parameters dependent filter comprises a list of parameters;
b. linkage, on the first computer system, of the created one or more parameters dependent filter with one or more preliminary created promo-campaigns; wherein the promo-campaign comprising an advertising and/or promotion information about one or more goods and/or services;
c. receiving, on the first computer system, the one or more parameters from the one or more computer systems;
d. identifying if one or more received parameters correspond with set of the parameters listed in the one or more parameters dependent filter;
e. distributing the one or more promo-campaigns with linked one or more necessary parameters dependent filter to the one or more computer systems, which previously sent the one or more parameters to the first computer system, if one or more received parameters correspond with set of parameters listed in the one or more parameters dependent filter.

14. A computer-implemented method for a customer involvement, comprising:
a. creating or obtaining from one or more external sources, on a first computer system, a one or more parameters dependent filter for further promo-campaign distribution, wherein the one or more parameters dependent filter comprises a list of parameters for selection;
b. linkage, on the first computer system, of the created one or more parameters dependent filter with one or more preliminary created promo-campaigns; wherein the promo-campaign comprising an advertising and/or promotion information about one or more goods and/or services, which can be purchased in one or more point of sales and/or electronically;
c. sending one or more requests, from one or more computer systems to the first computer system, for a list of one or more promo-campaigns, which correspond with set of parameters listed in the one or more parameters dependent filter, wherein the one or more requests comprises one or more parameters, corresponding to the one or more parameters dependent filter, of the one or more computer systems;
d. identifying if one or more received parameters correspond with one or more parameters listed in the one or more parameters dependent filter;
e. distributing a list of the one or more promo-campaigns with linked one or more necessary parameters dependent filter to the one or more computer systems, if one or more received parameters correspond with one or more parameters listed in the one or more parameters dependent filter, wherein the list of the one or more promo-campaigns comprises part of the advertising and/or promotion information about one or more goods and/or services.

15. The method of claim 14, further comprising:
a. receiving one or more events at the one or more computer systems;
b. updating the one or more parameters and/or values of the one or more parameters of the one or more computer systems;
c. sending one or more requests, from one or more computer systems to the first computer system, for a list of one or more promo-campaigns, which correspond with one or more parameters listed in the one or more parameters dependent filter, wherein the one or more requests comprises one or more updated parameters of the one or more computer systems;
d. identifying if one or more received parameters correspond with one or more parameters listed in the one or more parameters dependent filter;
e. distributing a list of the one or more promo-campaigns with linked one or more necessary parameters dependent filter to the one or more computer systems, if one or more received parameters correspond with one or more parameters listed in the one or more parameters dependent filter, wherein the list of the one or more promo-campaigns comprises part of the advertising and/or promotion information about one or more goods and/or services.

16. The method of any of the claims 1-15, wherein the one or more parameters dependent filter comprising one or combination of the following parameters:
a. one or more geographical objects;
b. one or more geographical areas;
c. one or more company names;
d. one or more indoor areas;
e. one or more dates;
f. one or more time;
g. one or more periods of time;
h. one or more virtual locations;
i. one or more terms of purchasing;
j. one or more persons personal identification information;
k. one or more persons credentials;
l. one or more terms of delivery;
m. promo-campaign identification information;
n. one or more companies identification information;
o. one or more legal documents, corresponding to the goods and/or services and/or terms of purchasing and/or terms of delivering and/or promo-campaign contents;
p. one or more links.

17. A non-transitory computer usable recording medium having computer executable one or more program logic stored thereon for executing on one or more processors, the one or more program logic comprising computer program code for implementing the steps of claims 1-16.

18. A system for a customer involvement, comprising:
a. one or more processors;
b. one or more devices for storing data;
c. one or more devices for establishing a network connection with one or more computer systems;
d. one or more programs, stored in the one or more devices for storing data and configured to be executed by the one or more processors, the one or more programs containing instructions for:
i. creating or obtaining from one or more external sources a one or more parameters dependent filter for further promo-campaign distribution, wherein the one or more parameters dependent filter comprises one or more parameters;
ii. linkage of the created one or more parameters dependent filter with one or more preliminary created promo-campaigns; wherein the promo-campaign comprising an advertising and/or promotion information about one or more goods and/or services;
iii. distributing the one or more promo-campaigns associated with linked set of parameters from the one or more parameters dependent filter to the one or more computer systems, which correspond with set of the parameters listed in the one or more parameters dependent filter.

19. The system of claim 18, wherein the one or more programs further comprising instructions for:
a. sending one or more requests to the one or more computer systems to identify if all or part of the computer systems, which previously received the one or more promo-campaigns, correspond with set of the parameters listed in the one or more parameters dependent filter;
b. if all or part of the computer systems don't correspond with set of the parameters listed in the one or more parameters dependent filter, the one or more promo-campaigns become unavailable for said all or part of the computer systems.

20. The system of claim 18 further comprising one or more computer systems, which have received part or whole of the one or more promo-campaigns, wherein the one or more computer systems comprises one or more devices for storing data #1, wherein the one or more computer systems comprising one or more processors #1, wherein the one or more computer systems comprises one or more programs #1, stored in the one or more devices for storing data #1 and configured to be executed on the one or more processors #1, the one or more programs #1 comprising instructions for:
a. interacting with the one or more promo-campaigns, on the one or more computer systems, to which the one or more promo-campaigns were distributed;
b. sending a notification about interaction, from the one or more computer systems, to which the one or more promo-campaigns were distributed; wherein the notification comprises information about interaction and information about one or more parameters listed in the one or more parameters dependent filter;
wherein the one or more programs further comprising instructions for:
a. analyzing the received notification about interaction;
b. creating a report about interaction, based on performed analysis; wherein the report comprises an information about comparison of received one or more parameters and one or more corresponding parameters listed in the one or more parameters dependent filter.

21. A system for a customer involvement, comprising:
a. one or more processors;
b. one or more devices for storing data;
c. one or more devices for establishing a network connection with one or more computer systems;
d. one or more programs, stored in the one or more devices for storing data and configured to be executed by the one or more processors, the one or more programs containing instructions for:
i. creating one or more promo-campaigns; wherein the promo-campaign comprises an advertising and/or promotion information about one or more goods and/or services and one or more parameters, corresponding to the one or more promo-campaigns distribution;
ii. receiving one or more parameters from one or more computer systems;
iii. distributing the one or more promo-campaigns to the one or more computer systems, If one or more received parameters correspond to one or more parameters of the one or more promo-campaigns.

22. A system for a customer involvement, comprising:
a. one or more processors;
b. one or more devices for storing data;
c. one or more devices for establishing a network connection with one or more computer systems;
d. one or more programs, stored in the one or more devices for storing data and configured to be executed by the one or more processors, the one or more programs containing instructions for:
i. creating or obtaining from one or more external sources a one or more parameters dependent filter for further promo-campaign distribution, wherein the one or more parameters dependent filter comprises a list of parameters;
ii. linkage of the created one or more parameters dependent filter with one or more preliminary created promo-campaigns; wherein the promo-campaign comprising an advertising and/or promotion information about one or more goods and/or services;
iii. receiving the one or more parameters from the one or more computer systems;
iv. identifying if one or more received parameters correspond with parameters listed in the one or more parameters dependent filter;
v. distributing the one or more promo-campaigns with linked one or more parameters dependent filter to the one or more computer systems, which previously sent the one or more parameters to the first computer system, if one or more received parameters correspond with set of parameters listed in the one or more parameters dependent filter.

23. A system for a customer involvement, comprising:
a. one or more processors;
b. one or more devices for storing data;
c. one or more devices for establishing a network connection with one or more computer systems;
d. one or more programs, stored in the one or more devices for storing data and configured to be executed by the one or more processors, the one or more programs containing instructions for:
i. creating or obtaining from one or more external sources a one or more parameters dependent filter for further promo-campaign distribution, wherein the one or more parameters dependent filter comprises a list of parameters;
ii. linkage of the created one or more parameters dependent filter with one or more preliminary created promo-campaigns; wherein the promo-campaign comprising an advertising and/or promotion information about one or more goods and/or services; wherein the one or more promo-campaigns are unavailable for all computer systems, except the system for a customer involvement;
iii. receiving the one or more parameters from the one or more computer systems;
iv. identifying if one or more received parameters correspond with set of the parameters listed in the one or more parameters dependent filter;
v. making available one or more promo-campaigns with linked one or more necessary parameters dependent filter to the one or more computer systems, which sent the one or more parameters to the first computer system, if one or more received parameters correspond with set of the parameters listed in the one or more parameters dependent filter.

24. The system of claim 23 further comprising one or more computer systems, which have received part or whole of the one or more promo-campaigns, wherein the one or more computer systems comprises one or more devices for storing data #1, wherein the one or more computer systems comprising one or more processors #1, wherein the one or more computer systems comprises one or more programs #1, stored in the one or more devices for storing data #1 and configured to be executed on the one or more processors #1, the one or more programs #1 comprising instructions for:
a. updating one or more parameters;
b. sending one or more updated parameters from the one or more computer systems to the first computer system;
wherein the one or more programs further comprising instructions for:
a. displaying the information about one or more promo-campaigns on the one more computer systems, if one or more updated parameters correspond with set of parameters listed in the one or more parameters dependent filter.

25. A system for a customer involvement, comprising:
a. one or more processors;
b. one or more devices for storing data;
c. one or more devices for establishing a network connection with one or more computer systems;
d. one or more programs, stored in the one or more devices for storing data and configured to be executed by the one or more processors, the one or more programs containing instructions for:
i. creating or obtaining from one or more external sources a one or more parameters dependent filter for further promo-campaign distribution, wherein the one or more parameters dependent filter comprises a list of parameters;
ii. linkage of the created one or more parameters dependent filter with one or more preliminary created promo-campaigns; wherein the promo-campaign comprising an advertising and/or promotion information about one or more goods and/or services;
iii. receiving the one or more parameters from the one or more computer systems;
iv. identifying if one or more received parameters correspond with set of the parameters listed in the one or more parameters dependent filter;
v. distributing the one or more promo-campaigns with linked one or more necessary parameters dependent filter to the one or more computer systems, which previously sent the one or more parameters to the first computer system, if one or more received parameters correspond with set of parameters listed in the one or more parameters dependent filter.

26. A system for a customer involvement, comprising:
a. one or more processors;
b. one or more devices for storing data;
c. one or more devices for establishing a network connection with one or more computer systems;
d. one or more programs, stored in the one or more devices for storing data and configured to be executed by the one or more processors, the one or more programs containing instructions for:
i. creating or obtaining from one or more external sources, on a first computer system, a one or more parameters dependent filter for further promo-campaign distribution, wherein the one or more parameters dependent filter comprises a list of parameters for selection;
ii. linkage, on the first computer system, of the created one or more parameters dependent filter with one or more preliminary created promo-campaigns; wherein the promo-campaign comprising an advertising and/or promotion information about one or more goods and/or services, which can be purchased in one or more point of sales and/or electronically;
iii. sending one or more requests, from one or more computer systems to the first computer system, for a list of one or more promo-campaigns, which correspond with set of parameters listed in the one or more parameters dependent filter, wherein the one or more requests comprises one or more parameters, corresponding to the one or more parameters dependent filter, of the one or more computer systems;
iv. identifying if one or more received parameters correspond with one or more parameters listed in the one or more parameters dependent filter;
v. distributing a list of the one or more promo-campaigns with linked one or more necessary parameters dependent filter to the one or more computer systems, if one or more received parameters correspond with one or more parameters listed in the one or more parameters dependent filter, wherein the list of the one or more promo-campaigns comprises part of the advertising and/or promotion information about one or more goods and/or services.

27. The system of claim 26 further comprising one or more computer systems, which have received part or whole of the one or more promo-campaigns, wherein the one or more computer systems comprises one or more devices for storing data #1, wherein the one or more computer systems comprising one or more processors #1, wherein the one or more computer systems comprises one or more programs #1, stored in the one or more devices for storing data #1 and configured to be executed on the one or more processors #1, the one or more programs #1 comprising instructions for:
a. receiving one or more events;
b. updating the one or more parameters and/or values of the one or more parameters of the one or more computer systems;
c. sending one or more requests, from one or more computer systems to the first computer system, for a list of one or more promo-campaigns, which correspond with one or more parameters listed in the one or more parameters dependent filter, wherein the one or more requests comprises one or more updated parameters of the one or more computer systems;
wherein the one or more programs further comprising instructions for:
a. identifying if one or more received parameters correspond with one or more parameters listed in the one or more parameters dependent filter;
b. distributing a list of the one or more promo-campaigns with linked one or more necessary parameters dependent filter to the one or more computer systems, if one or more received parameters correspond with one or more parameters listed in the one or more parameters dependent filter, wherein the list of the one or more promo-campaigns comprises part of the advertising and/or promotion information about one or more goods and/or services.
